(19) United States
(12) Patent Application Publication
(10) Pub. No.: US 2007/0033008 A1
(43) Pub. Date: Feb. 8, 2007

(54) Apparatus, method and program for evaluating validity of dictionary

(75) Inventors: Hironori Takuechi, Yokohama-shi (JP); Issei Yoshida, Tokyo (JP); Yohei Ikawa, Yamato-shi (JP)

Correspondence Address: RICHARD M. GOLDMAN, 371 ELAN VILLAGE LANE, SUITE 208, CA, 95134, US

(73) Assignee: International Business Machines Corporation

(21) Appl. No.: 11/498,433

(22) Filed: Aug. 3, 2006

(30) Foreign Application Priority Data
Aug. 4, 2005 (JP) JP-2005-228143

(51) Int. Cl. G06F 17/21

(52) U.S. Cl. 704/10

(57) ABSTRACT

Evaluate the validity of a dictionary in which a notation word is associated with a canonical word. This is accomplished using an apparatus which evaluates the validity of a dictionary for converting a notation word written in a text, the apparatus comprising: a dictionary recording portion which records, for each of word categories, at least one notation word in association with a canonical word representing the at least one notation word; a relation recording portion which records, on the condition that a canonical word of one category corresponds to a notation word of another category, the dependence relation that the one category depends on that other category; and an evaluation portion which evaluates, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word.

### FIELD OF THE INVENTION

The present invention relates to an apparatus, a method and a program for evaluating the validity of a dictionary. In particular, the present invention relates to an apparatus, a method and a program for evaluating the validity of a dictionary which converts a notation word written in a text.

### BACKGROUND ART

Conventional text mining has been suffered from a problem of fluctuation in notation of words. For example, there may be a case where a certain word appears in a certain text, while another word which has the same meaning but is differently notated appears in a different text. In this case, even if the words having the same meaning appear frequently, the frequency cannot be appropriately evaluated because their notations are not uniformed.

To cope with this, there has been used a technique for converting multiple notation words that are selected as words having the same meaning to a canonical word which represents the notation words. For example, in the case of determining the appearance distribution of a keyword belonging to a particular category, such as “product name”, notation words in a text are converted to a canonical word based on a dictionary corresponding to the category, which is prepared in advance. This dictionary includes conversion rules for converting a notation word to a canonical word.

As an example, in a gene category, any of a notation word “TAP1”, a notation word “ABC transporter, MHC 1”, a notation word “Cim”, a notation word “Abcb2”, a notation word “RING4” and a notation word “Ham 1” is converted to a canonical word “TAP 1”. That is, since all these notation words are synonymous with one another, they are uniformly processed as the canonical word “TAP1”. Especially in the field of life science, there is also a case where originally differently notation words have the same meaning, in addition to the case of notation fluctuation, and this conversion processing is indispensable for text mining in many cases.

It is necessary to uniquely create the conversion rules according to the application field or the purpose. Furthermore, the conversion rules may be generated from an external resource or may be manually generated by multiple creators. For example, a dictionary created by integrating multiple external resources is used for a lot of text mining solutions especially in the field of life science.

Generally, dictionaries used for text mining include the following two kinds: a dictionary in which each notation word is associated with a canonical word (hereinafter referred to as a notation word dictionary) and a dictionary in which each canonical word is associated with the category to which the canonical word belongs (hereinafter referred to as a category dictionary). In a lot of text mining solutions, such dictionaries are often created from multiple independent external resources. For example, in a text mining system intended for the field of life science, multiple resources like those shown below are used as dictionary resources.

Life science terms: UMLS (see Unified Medical Language System, URL: http://www.nlm. nih.gov/research/umls/);

Gene: LocusLink (see LocusLink, URL:

http://www.ncbi.nlm.nih.gov/entrez/query.gcgi?db=gene); and

Protein: SwissProt (see SwissProt, URL: http://www.ebi.ac.uk/swissprot/).

The LocusLink and the SwissProt described above are databases open to the public which are related to gene information and protein information, and they are not constructed as dictionaries for text processing. The UMLS itself is a huge resource which is created from a lot of resources. By creating a notation word dictionary based on these existing resources, a dictionary covering a lot of vocabulary can be efficiently created. A notation word dictionary can be also created by utilizing a dictionary system in which multiple external resources are integrated (see VisionClaire, URL:

http://www.hitachi.co.jp/products/lifescience/product/tool/document/2002564_{—}12525.htm l, and Koike and Takagi, Gene/protein/family name recognition in biomedical literature, BioLINK2004, and Tuason, O. and Chen, L., Liu, H., Blake, J. A., and Friedman, C. 2004. Proc. of Pacific Symposium on Biocomputing, 238-249.

However, when a dictionary is created by integrating multiple different external resources, there may be a case where a word which can interfere with statistical processing or search processing in text mining may be mixed in the dictionary. Such a word is called a noise entry. The noise entry is considered to occur when an external resource is not created for the purpose of language processing or when an external resource is not sufficiently managed because the number of entries of the resource is enormous and the entries are updated every day.

For example, in a certain external resource, “Spna2”, which is a canonical word of the gene category, is associated with a notation word “brain” (Spna2 is the name of a certain gene). In this case, since the appearance frequency of “brain” is very high in comparison with a particular gene name, the appearance frequency of “Spna2” is much higher than its proper frequency. Additional inappropriate examples of a canonical word and a corresponding notation word are shown below.

A notation word “beta” corresponding to a canonical word “NR1D2”. A notation word “8.5” corresponding to a canonical word “Nsg2”. A notation word “mg” corresponding to a canonical word “ATRN”. A notation word “Net” corresponding to a canonical word “ELK3”. A notation word “703” corresponding to a canonical word “ASH2L”. A notation word “7-7” corresponding to a canonical word “D2Dcr32”. A notation word “6.6” corresponding to a canonical word “PFKM”. A notation word “3603” corresponding to a canonical word “RBPMS”.

Among these, numerals and units can be excluded from a dictionary by setting them as words which should not be recorded on the dictionary in advance. However, if setting of such words is left to a user as his work, the accuracy differs depending on the experience and ability of the user. Furthermore, it is difficult to remove all such words. As for general words which appear at a higher frequency than a criterion, a method is conceivable in which such words are excluded from a dictionary as words which may be noise entries with high possibility (see Non-Patent Documents 5 and 6).

In these techniques, determination whether a word is a general word or not is made by utilizing a general word dictionary. However, this technique has a problem that, since it is not possible to make a clear distinction between a general word and a technical term, even a technical term is deleted from a dictionary if it is included the general word dictionary.

In the case of creating a dictionary by integrating multiple external resources, a notation word of a category may correspond to the canonical word of another category. Heretofore, it has been impossible to determine the validity of a dictionary in consideration of relation among categories when, as in the above case, multiple categories include the same word.

Accordingly, the object of the present invention is to provide an apparatus, a method and a program capable of solving the above problems. This object is achieved by combination of the characteristics described in the independent claims in the claims. The dependent claims provide further advantageous concrete examples of the present invention.

### SUMMARY OF THE INVENTION

In order to solve the above problems, in the first embodiment of the present invention, there are provided an apparatus which evaluates the validity of a dictionary for converting a notation word written in a text, the apparatus comprising: a dictionary recording portion which records, for each of word categories, at least one notation word in association with a canonical word representing the at least one notation word; a relation recording portion which records, on the condition that a canonical word of one category corresponds to a notation word of another category, the dependence relation that the one category depends on the another category; and an evaluation portion which evaluates, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word; a method for evaluating the validity of a dictionary by the apparatus; and a program for causing an information processing apparatus to function as the apparatus.

In the second embodiment of the present invention, there are provided an apparatus which evaluates the validity of a dictionary for converting a notation word written in a text, the apparatus comprising: a dictionary recording portion which records, for each of word categories, at least one notation word in association with a canonical word representing the at least one notation word; a frequency recording portion which records a reference frequency, which is the appearance frequency at which a predetermined reference word appears in a predetermined reference text of a predetermined reference category; a frequency calculation portion which calculates the appearance frequency at which a notation word recorded for the reference category in the dictionary recording portion appears in the reference text; and an evaluation portion which evaluates, on the condition that the deviance of the appearance frequency calculated by the frequency calculation portion relative to the reference frequency is smaller, the validity of the notation word higher in comparison with the case where the deviance is larger; a method for evaluating the validity of a dictionary by the apparatus; and a program for causing an information processing apparatus to function as the apparatus.

In the third embodiment of the present invention, there are provided an apparatus which evaluates the validity of a dictionary for converting a notation word written in a text, the apparatus comprising: a dictionary recording portion which records at least one notation word in association with a canonical word representing the at least one notation word; a text recording portion which records multiple texts by classifying them under respective categories; a distribution recording portion which records, for a set of texts including a predetermined reference word, the distribution of the number of texts for each category; a distribution generation portion which generates, for texts including the notation word recorded in the dictionary recording portion among the multiple texts recorded in the text recording portion, the distribution of the number of texts for each category; and an evaluation portion which evaluates, on the condition that the deviance between the distribution of the number of texts recorded in the distribution recording portion and the distribution of the number of texts generated by the distribution generation portion is smaller, the validity of the notation word higher in comparison with the case where the deviance is larger; a method for evaluating the validity of a dictionary by the apparatus; and a program for causing an information processing apparatus to function as the apparatus.

The above summary of the invention does not enumerate all necessary characteristics of the present invention, and sub-combination of these characteristic groups can be the invention.

According to the present invention, it is possible to evaluate the validity of a dictionary in which a notation word is associated with a canonical word.

### BRIEF DESCRIPTION OF THE DRAWINGS

FIG. 1 shows the outline of an evaluation apparatus 10;

FIG. 2 shows an example of the data structure of a dictionary recording portion 100;

FIG. 3 shows the functional configuration of an evaluation unit 20;

FIG. 4 shows the data structure of a relation recording portion 110;

FIG. 5 shows an example of the data structure of a frequency recording portion 150;

FIG. 6 shows an example of the data structure of a distribution recording portion 170;

FIG. 7 shows a process flow of the processing for evaluating the validity of a notation word performed by the evaluation apparatus 10;

FIG. 8 shows the details of processing performed at S710;

FIG. 9 shows the details of processing performed at S730;

FIG. 10 shows the details of processing performed at S750; FIG. 11 shows a variation example of the processing at S750; and

FIG. 12 shows an example of the hardware configuration of an information processing apparatus 500 which functions as the evaluation apparatus 10.

### DETAILED DESCRIPTION

The present invention will be described below through embodiments of the invention. The embodiments described below, however, do not limit the invention to the claims, and all the combinations of characteristics described in the embodiments are not necessarily required for solution means of the invention.

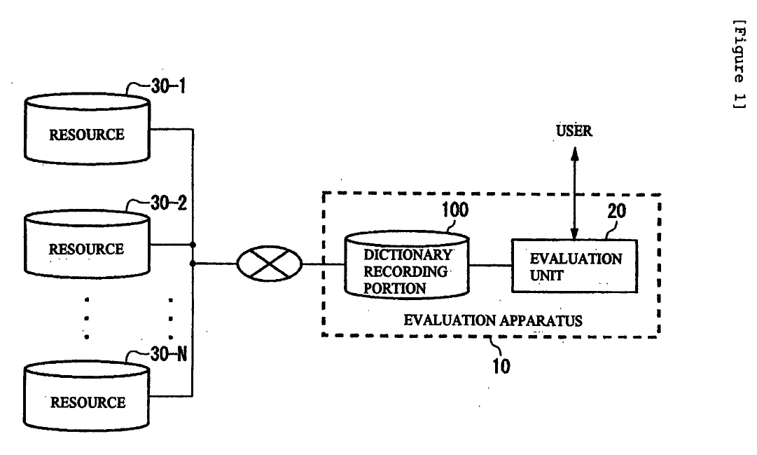

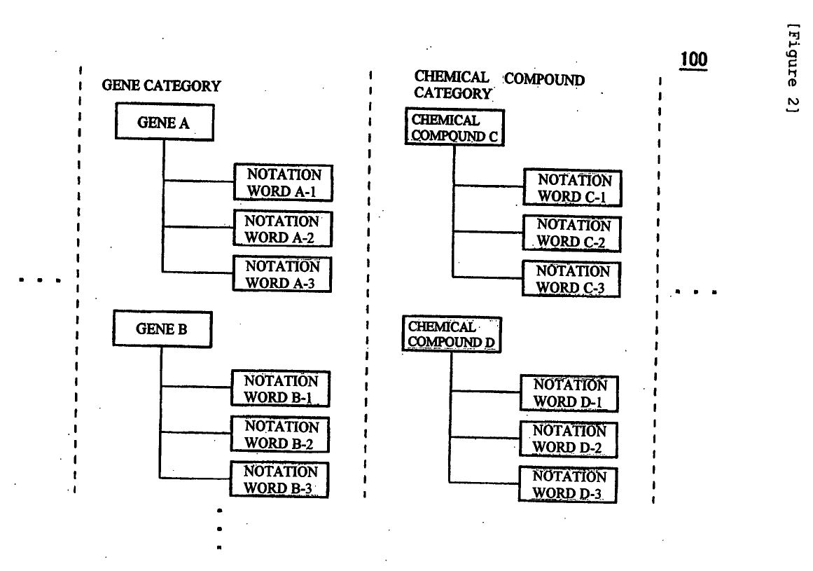

FIG. 1 shows the outline of an evaluation apparatus 10. The evaluation apparatus 10 is provided with an evaluation unit 20 and a dictionary recording portion 100. The evaluation unit 20 evaluates the validity of a dictionary for converting a notation word written in a text. In the dictionary recording portion 100, at least one notation word is recorded in association with a canonical word representing the at least one notation word, for each word category. Specifically, the dictionary recording portion 100 acquires pairs of a notation word and a canonical word from each of resources 30-1 to 30-N connected via a network, and integrates and records them.

In this case, the resources 30-1 to 30-N may be managed by different administrators, and may not be constructed exclusively for text mining. Therefore, association of a notation word and a canonical word with each other may be inappropriate. The evaluation apparatus 10 according to this embodiment is intended to prompt a user to delete unnecessary words or correct inappropriate words by evaluating the validity of a dictionary recorded in the dictionary recording portion 100.

FIG. 2 shows an example of the data structure of the dictionary recording portion 100. In the dictionary recording portion 100, at least one notation word is recorded in association with a canonical word representing the at least one notation word, for each word category. Words to be recorded in the dictionary recording portion 100 are technical terms such as chemical names and names of bases constituting a gene, for example. The dictionary recording portion 100 records such technical terms for each of technical field categories in which they are used. For example, the dictionary recording portion 100 has a gene category and a chemical compound category as the word categories.

A notation word is a notation of a word included in a text to be targeted by text mining. In a text, multiple different notation words having the same meaning may be written due to the personality of the creator of the text or for some other reason. Therefore, if a notation word is targeted by text mining, the appearance frequency of such words having the same meaning cannot be appropriately evaluated. Therefore, in order to evaluate multiple notation words having the same meaning by integrating them, the dictionary recording portion 100 records a dictionary for converting such notation words to the same canonical word.

Specifically, in order to convert each of a notation word A-1, a notation word A-2, and a notation word A-3 to a canonical word, gene A, the dictionary recording portion 100 records these notation words in association with gene A. Similarly, in order to convert each of a notation word C-1, a notation word C-2, and a notation word C-3 to a canonical word, chemical compound C, the dictionary recording portion 100 records the notation word C-1, the notation word C-2, and the notation word C-3 in association with chemical compound C.

In this case, the relation between a notation word and a canonical word is the relation that they have the same meaning. Alternatively, a canonical word may be a common name of notation word. For example, it may be the same as one notation word selected from multiple notation words. The canonical word may be a generic name of notation words.

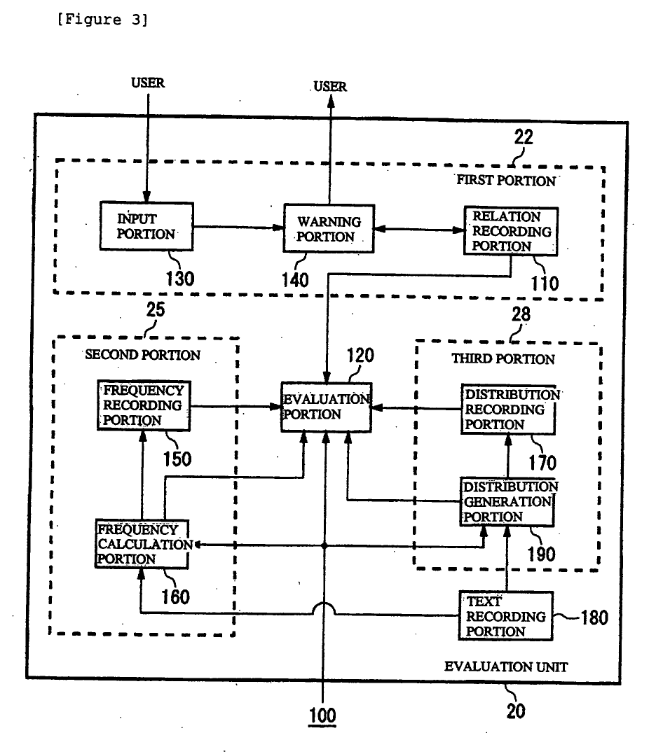

FIG. 3 shows the functional configuration of the evaluation unit 20. The evaluation unit 20 evaluates the validity of a notation word by a combination of three methods. Specifically, the evaluation unit 20 has a first portion 22 for evaluating the validity of a notation word by a first method, a second portion 25 for evaluating the validity of a notation word by a second method and a third portion 28 for evaluating the validity of a notation word by a third method. The evaluation unit 20 also has an evaluation portion 120 for comprehensively evaluate the validity based on these methods and a text recording portion 180 in which a text used for evaluation is recorded.

The first portion 22 has a relation recording portion 110, an input portion 130 and a warning portion 140. The relation recording portion 110 records, on condition that one category corresponds to a notation word of another category, the dependence relation that the one category depends on that other category. The evaluation portion 120 determines the validity of the notation word with the use of this dependence relation. Specifically, the evaluation portion 120 determines whether or not the canonical word of a first category corresponds to a notation word of a second category in the dictionary recording portion 100. Then, on the condition that the canonical word corresponds to a notation word, the evaluation portion 120 determines whether or not the dependence relation that the first category depends on the second category is recorded in the relation recording portion 110. On the condition that the dependence relation is not recorded, the evaluation portion 120 evaluates the notation word to be invalid as a word represented by the canonical word.

A category may be added to the categories recorded in the relation recording portion 110, by specification by a user. Specifically, the input portion 130 inputs specification of a new category by the user in association with the dependence relation that the new category depends on another category or the dependence relation that other category depends on the new category. Then, the warning portion 140 determines whether dependence circulation relation exists, based on the inputted dependence relation and dependence relations already recorded in the relation recording portion 110.

In this case, the dependence circulation relation means, for example, such relation that one category depends on a new category, the new category depends on another category, and that other category depends on the one category. On condition that such circulation relation is detected, the warning portion 140 gives a warning to the user to the effect that dependence relation is inappropriate to prompt the user to correct the dependence relation. If the circulation relation is not detected, the warning portion 140 records the inputted dependence relation in the relation recording portion 110.

The second portion 25 has a frequency recording portion 150 and a frequency calculation portion 160. The frequency recording portion 150 records a reference frequency, which is an appearance frequency at which a predetermined reference word appears, in a predetermined reference text in a predetermined reference category. In this case, the reference word is a word selected in advance by an administrator or the like of a dictionary or the like as a typical example of a notation word. The reference frequency may be calculated by the frequency calculation portion 160. The frequency calculation portion 160 calculates the appearance frequency at which a notation word recorded for the reference category appears in the reference text, in the dictionary recording portion 100. For example, the reference text is recorded in the text recording portion 180, and the frequency calculation portion 160 may acquire the reference text from the text recording portion 180 and calculate the appearance frequency of the notation word in the reference text.

On the condition that the deviance, which is to be described later, of the appearance frequency calculated by the frequency calculation portion 160 relative to the reference frequency recorded in the frequency recording portion 150 is smaller, the evaluation portion 120 evaluates the validity of the notation word to be higher in comparison with the case where the deviance is larger.

The third portion 28 has a distribution recording portion 170 and a distribution generation portion 190. The distribution recording portion 170 records, for a set of texts including a predetermined reference word, distribution of the number of texts for each text attribute. This distribution may be generated by the distribution generation portion 190. The distribution generation portion 190 acquires each of the multiple texts from the text recording portion 180 in association with the attribute of the text. The distribution generation portion 190 generates, for texts including a notation word recorded in the dictionary recording portion 100 among the multiple texts, distribution of the number of text for each attribute.

In this case, the text attribute is an identifier attached to a text for the purpose of classifying and managing the text, such as an identifier indicating the classification of the content of the text and an identifier indicating the creator or the creation organization of the text. Specifically, a text creator may include this attribute in a text when starting creation of the text, or a text administrator may add this attribute to a text when registering the text to a database. This attribute may be a concept different from the above-described category.

On the condition that the deviance between the distribution of the number of texts recorded in the distribution recording portion 170 and the distribution of the number of texts generated by the distribution generation portion 190 is smaller, the evaluation portion 120 evaluates the validity of the notation word to be higher in comparison with the case where the deviance is larger.

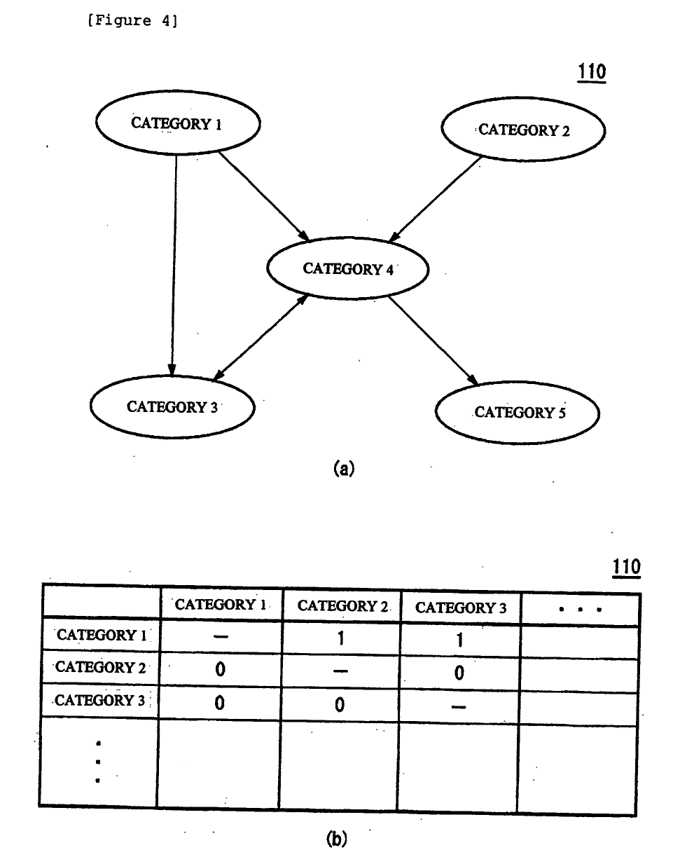

FIG. 4 shows the data structure of the relation recording portion 110. On the condition that the canonical word of one category corresponds to a notation word of another category, the relation recording portion 110 records the dependence relation that the one category depends on that other category. For example, in FIG. 4(a), each circle indicates a category, and each arrow connecting circles indicates dependence relation. That is, a category 1 depends on categories 3 and 4. The categories 3 and 4 depend on each other. That is, the canonical word of the category 1 can correspond to a notation word of the category 3 or 4. The canonical word of the category 3 can correspond to a notation word of the category 4. The canonical word of the category 4 can correspond to a notation word of the category 3.

An example of a concrete data structure is shown in FIG. 4(b). The relation recording portion 110 records a flag indicating whether or not dependence relation exists, in a tabular form structure in which respective categories are arranged in lines and respective categories are arranged in columns. For example, the element at the position where the category 1 arranged in a column and the category 2 arranged in a line intersect with each other is 1, and therefore, the category 1 has the dependence relation that it depends on the category 2.

Instead, the relation recording portion 110 may record dependence degree indicating the degree of dependence relation of each category depending on each of other categories. For example, in the tabular form structure shown in FIG. 4(b), the relation recording portion 110 may record the dependence degree indicating the degree of dependence relation as each element of the table. The dependence degree of the category 1 depending on the category 2 is indicated by P (1, 2). That is, P (1, 2) indicates the degree of possibility that the canonical word of the category 1 corresponds to a notation word of the category 2.

In this example, if a flag indicating that the category 1 depends on the category 2 is recorded, then the evaluation portion 120 determines that there is dependence relation. If the dependence degree P (1, 2) is defined, then it is determined that there is dependence relation on the condition that the dependence degree is equal to or above a certain threshold. The dependence degree between categories can be defined by the user based on his knowledge. It may be calculated based on information obtained from an external resource.

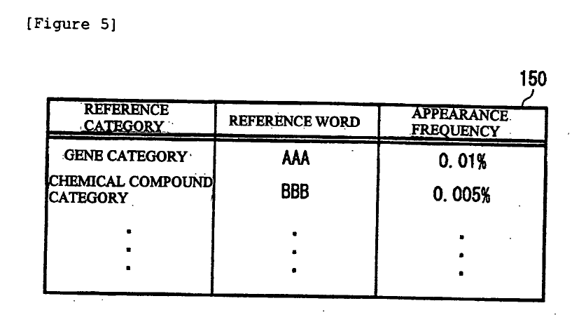

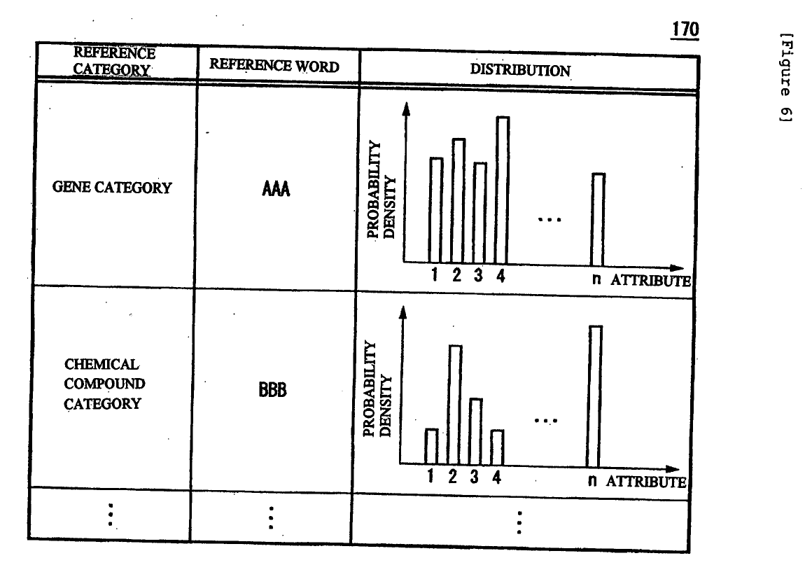

FIG. 5 shows an example of the data structure of the frequency recording portion 150. The frequency recording portion 150 records a reference frequency, which is an appearance frequency at which a predetermined reference word appears, in a predetermined reference text in a predetermined reference category. For example, the frequency recording portion 150 records 0.01% as the frequency at which a reference word AAA in the gene category, which is a reference category, appears. This appearance frequency indicates the rate of AAA's among all the words included in the reference text. Instead, the appearance frequency may be the number of times a reference word appears per text page or the number of times a reference word appears per 1 KB of text data.

FIG. 6 shows an example of the data structure of the distribution recording portion 170. For each category, the distribution recording portion 170 records, for a set of texts including a predetermined reference word included in each category, distribution of the number of texts for each text attribute. For example, as shown in the figure, the distribution recording portion 170 records, for a set of texts including AAA, which is the reference word of the gene category, among multiple texts recorded in the frequency calculation portion 160, the distribution of the number of texts for each attribute. The distribution of the number of texts for each attribute means distribution of the number of texts according to attribute values in which, for example, the probability density of a text with the attribute value of 1 is 10%, and the probability density of a text with the attribute value of 2 is 12%.

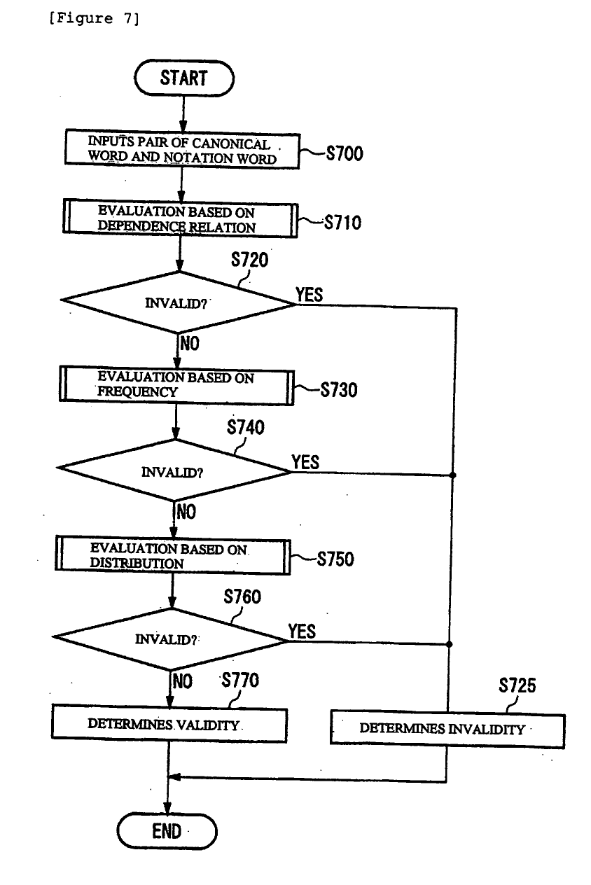

FIG. 7 shows a process flow of the processing for evaluating the validity of a notation word performed by the evaluation apparatus 10. The evaluation portion 120 inputs a pair of a notation word to be targeted by validity evaluation and a corresponding canonical word from the dictionary recording portion 100 (S700). Hereinafter, the category including this notation word is assumed to be a category A. Then, the evaluation portion 120 evaluates the validity of the notation word based on the dependence relation among categories (S710). For example, on the condition that this notation word in the category A corresponds to a canonical word in another category in the dictionary recording portion 100, and that the dependence relation of that other category depending on the category A is not recorded in the relation recording portion 110, the evaluation portion 120 evaluates that this notation word is invalid.

On the condition that the notation word is evaluated to be invalid (S720: YES), the evaluation portion 120 determines that the notation word is invalid (S725) and terminates the processing. On the other hand, on the condition that the above-described dependence relation is recorded (S720: NO), the evaluation portion 120 evaluates the validity of the notation word based on the appearance frequency of the notation word (S730). For example, on the condition that the deviance of the appearance frequency calculated by the frequency calculation portion 160 relative to the reference frequency is larger than a predetermined criterion, the evaluation portion 120 evaluates the notation word to be invalid.

On the condition that the notation word is evaluated to be invalid (S740: YES), the evaluation portion 120 determines that the notation word is invalid (S725) and terminates the processing. On the other hand, on the condition that the above-described deviance is equal to or below the predetermined reference (S740: NO), the evaluation portion 120 evaluates the validity of the notation word based on the distribution of the number of texts for each attribute in a group of texts including the notation word (S750). For example, on the condition that the deviance between the distribution of the number of texts recorded in the distribution recording portion 170 and the distribution of the number of texts generated by the distribution generation portion 190 is larger than a predetermined criterion, the evaluation portion 120 evaluates that the notation word is invalid.

On the condition that the notation word is evaluated to be invalid (S760: YES), the evaluation portion 120 determines that the notation word is invalid (S725) and terminates the processing. On the other hand, on the condition that the notation word is evaluated to be valid (S760: NO), the evaluation portion 120 determines that the notation word is valid (S770) and terminates the processing.

As described above with reference to the figure, the evaluation apparatus 10 determines the validity of a notation word by sequentially performing each of the first to third methods in that order. Here, considering the processing time required for each method, the first method requires only the processing for acquiring dependence degree from the relation recording portion 110, and the processing time is extremely short. The second method requires calculation of an appearance frequency and calculation of a deviance, and the processing time is considered to be longer than that required for the first method. Furthermore, the third method requires processing for calculating distribution of the number of texts, and the processing time is considered to be longer than the second method. Thus, the evaluation apparatus 10 in this embodiment sequentially performs the first to third methods in ascending order of processing time, and the next method is performed only when the validity is not known by the previous method. Thereby, it is possible to shorten the time required for the entire processing for evaluating validity and enhance the efficiency.

The flow of the processing in this figure is only an example, and various means for combining the first to third methods are conceivable. For example, the evaluation portion 120 may quantify the validity obtained by evaluating a notation word by each of the first to third methods and regards the total of the numeric values as the validity of the notation word.

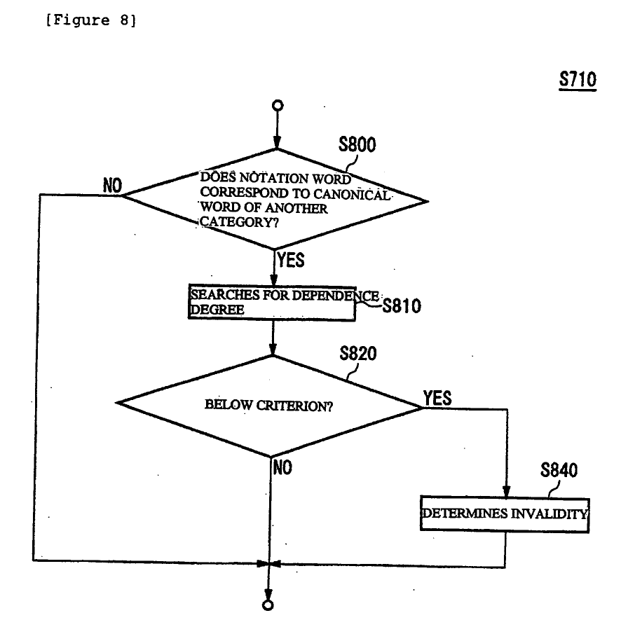

FIG. 8 shows the details of the processing performed at S710. The evaluation portion 120 determines whether the notation word targeted by evaluation corresponds to a canonical word in any of other categories in the dictionary recording portion 100 (S800). If it does not correspond to a canonical word in any of other categories (S800: NO), then the processing in the figure is terminated. On the other hand, on the condition that the notation word corresponds to a canonical word in any of other categories (S800: YES), then the evaluation portion 120 searches for the degree of dependence that other category depends on the category A, from the relation recording portion 110. Hereinafter, that other category is assumed to be a category B.

More specifically, the evaluation portion 120, regarding the category A as a column element and the category B as a line element, searches for an element in the table shown in FIG. 4(b) and determines the dependence degree of the category A depending on the category B. This element is indicated by P (A, B). This element P (A, B) is evaluated as the validity of the notation word. Then, if the evaluated validity is below a criterion (S820: YES), then the evaluation portion 120 evaluates that the notation word is invalid (S840).

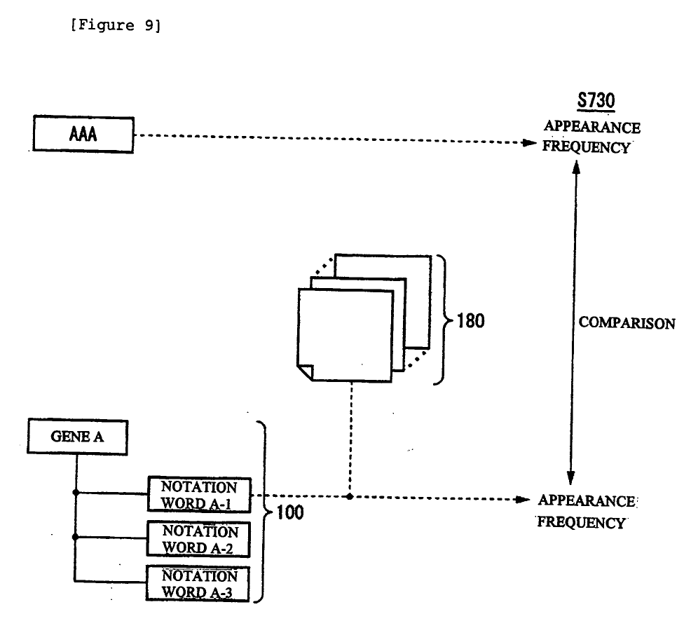

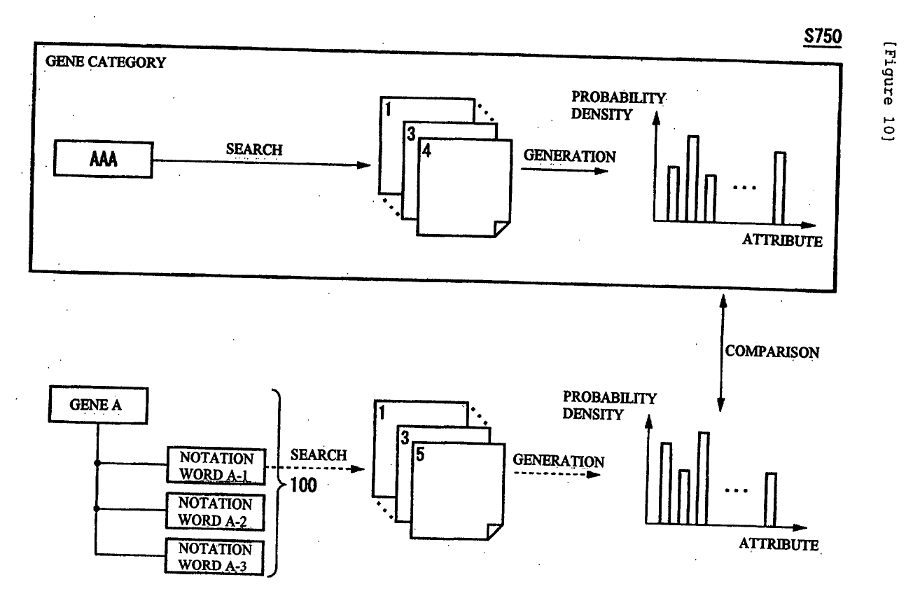

FIG. 9 shows the details of the processing performed at S730. The frequency recording portion 150 records a reference frequency, which is the appearance frequency at which AAA, a predetermined reference word, appears in a predetermined reference text in a reference category. This reference text is, for example, a set of texts recorded in the text recording portion 180. Then, the frequency calculation portion 160 sequentially selects notation words recorded for the reference category in the dictionary recording portion 100. Now, a selected notation word is assumed to be a notation word A-1. The frequency calculation portion 160 calculates the appearance frequency at which the notation word A-1 appears in the reference text in the text recording portion 180.

Next, the evaluation portion 120 compares the appearance frequency calculated by the frequency calculation portion 160 and the reference frequency recorded in the frequency recording portion 150. The evaluation portion 120 then calculates the deviance between these frequencies. The method for determining the frequency deviance has been well known. As the simplest method, a value of difference between the value of the reference frequency (q) and the value of the calculated appearance frequency may be determined as the deviance. Alternatively, the ratio of the frequency values (p/q) may be determined as the deviance. In addition, the evaluation portion 120 may determine a Kullback-Leibler distance (KL(q|p)) between the frequencies as the deviance, determine a test statistic (H0p=q) based on the assumption that these frequencies are equal, as the deviance, or determine the deviance with the use of AIC (information amount criterion).

Next, on the condition that the calculated deviance is larger than a predetermined criterion, the evaluation portion 120 evaluates that the notation word is invalid. In this case, if it is difficult to determine a reference word in advance, the frequency calculation portion 160 may calculate the appearance frequency for each of a notation word recorded in the dictionary recording portion 100 and a canonical word corresponding thereto. Then, the frequency recording portion 150 records the canonical word as a reference word, and the appearance frequency of the canonical word as a reference frequency. In this case, the evaluation portion 120 evaluates the validity of the notation word based on the deviance of the appearance frequency of the notation word relative to the reference frequency of the canonical word.

As another example, the evaluation portion 120 may evaluate the validity of a notation word with the use of two reference frequencies at which two predetermined reference words appear, respectively, in order to enhance the accuracy of the validity evaluation. These two reference words are assumed to be first and second reference words. The appearance frequency of the first reference word is assumed to be q1; the appearance frequency of the second reference word is assumed to be q2; and it is assumed that q1>q2.

That is, in this case, the frequency recording portion 150 records the appearance frequency (q1) at which the first reference word appears in the reference text, and the appearance frequency (q2) at which the second reference word appears in the reference text. The first reference word is a high-frequency word which is known in advance to appear at a higher frequency than the average of the appearance frequencies at which respective words appear in the reference category. The second reference word is a common word which is known in advance to appear at the average of the appearance frequencies at which respective words appear in the reference category.

On the condition that the appearance frequency (p) calculated for the notation word by the frequency calculation portion 160 is higher than the appearance frequency of one of the first and second reference words (for example, q2) and lower than the other appearance frequency (for example, q1), the evaluation portion 120 evaluates the validity of the notation word higher than when the appearance frequency is higher than both of the appearance frequencies of the first and second reference words. For example, when the appearance frequency (p) is higher than both of the appearance frequencies (q1 and q2) of the first and second reference words, the evaluation portion 120 evaluates that the notation word is invalid. On the other hand, on the condition that the appearance frequency (p) is higher than the appearance frequency of one of the first and second reference words (for example, q2) and lower than the appearance frequency of the other (for example, q1), the evaluation portion 120 evaluates that there is a possibility that the notation word is valid. In this case, for example, the evaluation portion 120 may proceed to the processing at S750 and perform evaluation based on distribution of the number of texts.

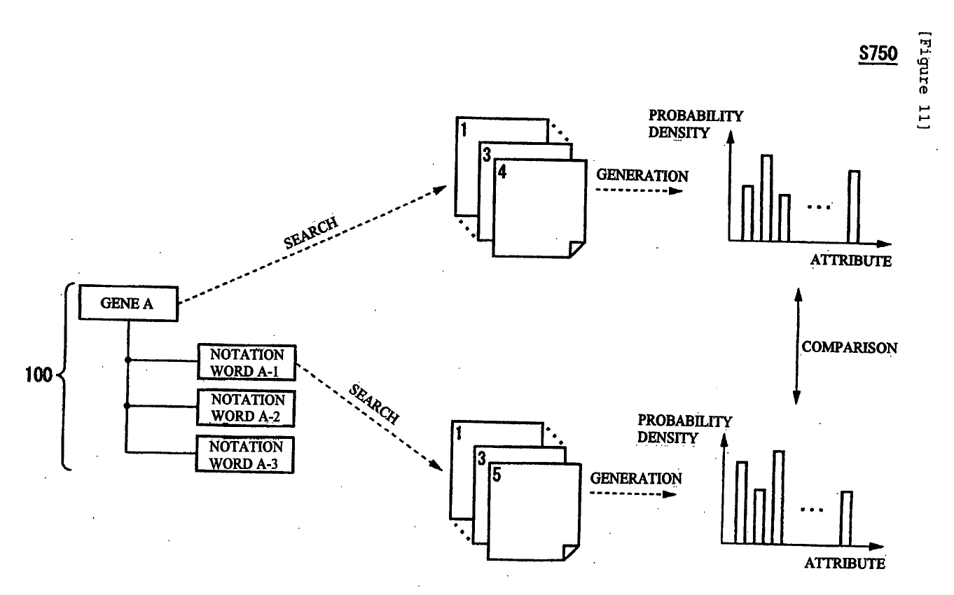

FIG. 10 shows the details of the processing performed at S750. The distribution recording portion 170 records, for a set of texts including a reference word (for example, AAA), the distribution of the number of texts for each text attribute. That is, in order to determine the distribution, the set of texts including the reference word (AAA) is searched for from the text recording portion 180 first. The search target is not limited to the text recording portion 180, and any text of a category to which the reference word belongs can be a target. Then, for each text included in the set of texts, the attribute of the text is checked. The distribution of the attribute value of the attribute is to be the distribution recorded in the distribution recording portion 170. This distribution may be, for example, probability density distribution of the number of texts for the attribute value.

The distribution generation portion 190 selects a notation word to be targeted by validity evaluation from the dictionary recording portion 100. This notation word is assumed to be a notation word A-1. Then, the distribution generation portion 190 acquires each of the multiple texts in association with the attribute of the text, from the text recording portion 180. The distribution generation portion 190 generates, for texts including the notation word A-1 among the multiple texts, distribution of the number of texts for each attribute. The evaluation portion 120 then calculates the deviance between the distribution of the number of texts recorded in the distribution recording portion 170 and the distribution of the number of texts generated by the distribution generation portion 190. A well-known conventional method can be applied as the method for determining the distribution deviance. For example, the deviance can be calculated based on the Kullback-Leibler distance, which has already been described with reference to FIG. 9. Then, on the condition that the calculated deviance is larger than a predetermined criterion, the distribution generation portion 190 evaluates that the notation word is invalid.

FIG. 11 shows a variation example of the processing at S750. In the example in FIG. 10, it is necessary to select a suitable reference word in order to suitably evaluate validity. A reference word can be suitably selected by an administrator familiar with the category to which the reference word belongs. If a lot of texts of the category can be sufficiently prepared, a reference word can be selected from the words which appear in the texts. In this variation example, description will be made on processing for evaluating the validity of a notation word without specifying a reference word in advance so that validity can be evaluated in other cases.

First, the distribution generation portion 190 selects a pair of a notation word to be targeted by validity evaluation and a canonical word corresponding thereto, from the dictionary recording portion 100. The selected canonical word is assumed to be gene A, and the selected notation word is assumed to be a notation word A-1. The distribution generation portion 190 then retrieves a set of texts including the canonical word from the text recording portion 180. The distribution generation portion 190 also retrieves a set of texts including the notation word A-1 from the text recording portion 180. The distribution generation portion 190 generates, for the set of texts including the canonical word, distribution of the number of texts for each attribute.

The distribution recording portion 170 records the generated distribution, with the canonical word as a reference word. The distribution generation portion 190 generates, for the set of texts including the notation word A-1, distribution of the number of texts for each attribute. Then, the evaluation portion 120 compares the distribution of the number of texts generated by the distribution generation portion 190 for the notation word A-1 and the distribution with the canonical word corresponding to the notation word used as a reference word to determine the deviance therebetween. On the condition that the deviance is larger than a predetermined criterion, the evaluation portion 120 evaluates that the notation word is invalid.

As described above, according to this variation example, it is possible to suitably evaluate the validity of a notation word without specifying a reference word in advance.

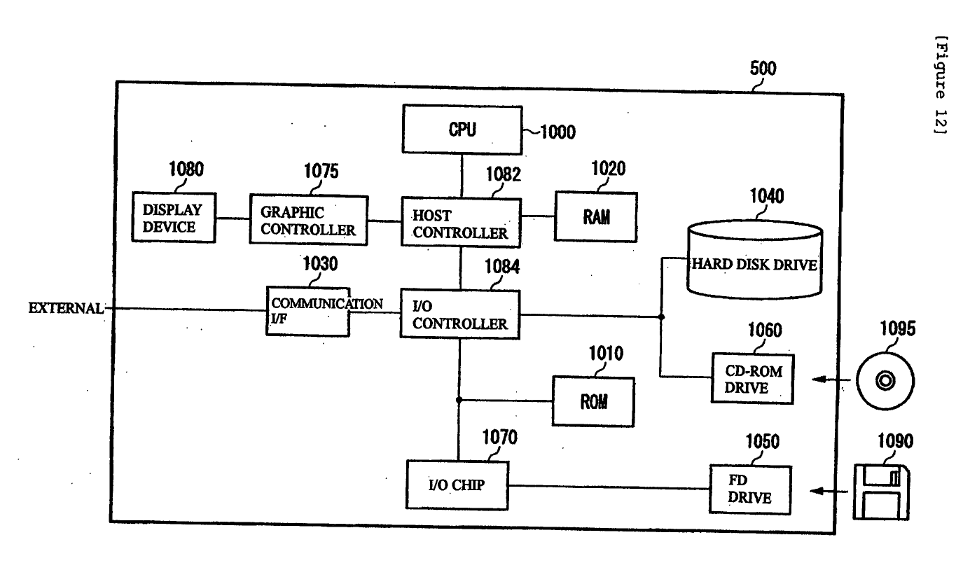

FIG. 12 shows an example of the hardware configuration of an information processing apparatus 500 which functions as the evaluation apparatus 10. The information processor 500 is provided with a CPU peripheral part having a CPU 1000, a RAM 1020 and a graphic controller 1075 which are mutually connected via a host controller 1082; an input/output part having a communication interface 1030, a hard disk drive 1040 and a CD-ROM drive 1060 which are connected to the host controller 1082 via an input/output controller 1084; and a legacy input/output part having a ROM 1010, a flexible disk drive 1050 and an input/output chip 1070 which are connected to the input/output controller 1084.

The host controller 1082 connects the RAM 1020 to the CPU 1000 and the graphic controller 1075 which access the RAM 1020 at a high transfer rate. The CPU 1000 operates based on programs stored in the ROM 1010 and the RAM 1020 to control each part. The graphic controller 1075 acquires image data generated by the CPU 1000 or the like on a frame buffer provided in the RAM 1020, and displays it on a display device 1080. Alternatively, the graphic controller 1075 may include the frame buffer for storing image data generated by the CPU 1000 and the like, inside it.

The input/output controller 1084 connects the host controller 1082 to the communication interface 1030, the hard disk drive 1040 and the CD-ROM drive 1060 which are relatively high speed input/output devices. The communication interface 1030 communicates with an external device via a network. The hard disk drive 1040 stores programs and data to be used by the information processing apparatus 500. For example, the hard disk drive 1040 may function as the dictionary recording portion 100 shown in FIG. 1. The CD-ROM drive 1060 reads a program or data from a CD-ROM 1095 and provides it to the RAM 1020 or the hard disk drive 1040.

The ROM 1010 and relatively low speed input/output devices, such as the flexible disk drive 1050 and the input/output chip 1070, are connected to the input/output controller 1084. The ROM 1010 stores a boot program, which is executed by the CPU 1000 when the information processor 500 is activated, and programs dependent on the hardware of the information processor 500. The flexible disk drive 1050 reads a program or data from a flexible disk 1090 and provides it to the RAM 1020 or the hard disk drive 1040 via the input/output chip 1070. The input/output chip 1070 connects the flexible disk 1090 or connects various input/output devices, for example, via a parallel port, serial port, a keyboard port, a mouse port or the like.

A program to be provided for the information processor 500 is stored in a recording medium such as the flexible disk 1090, the CD-ROM 1095 and an IC card, and provided by a user. The program is read from the recording medium via the input/output chip 1070 and/or the input/output controller 1084, installed in the information processing apparatus 500 and executed. The operations which the program causes the information processing apparatus 500 to perform are the same as the operations performed by the evaluation apparatus 10 described through FIGS. 1 to 11, and description thereof will be omitted.

The program described above may be stored in an external storage medium. As the storage medium, an optical recording medium such as a DVD and a PD, a magneto-optic recording medium such as an MD, a tape medium, and a semiconductor memory such as an IC card may be used, in addition to the flexible disk 1090 and the CD-ROM 1095. It is also possible to use a storage device such as a hard disk and a RAM provided for a server system connected to a dedicated communication network or the Internet to provide the program to the information processor 500 via the network.

The present invention has been described with the use of embodiments. However, the technical scope of the present invention is not limited to the range described in the above embodiments. It is apparent to those skilled in the art that various modifications or improvements can be made to the embodiments described above. It is apparent from the description of the claims that such modified or improved embodiments can be included in the technical scope of the present invention.

1. An apparatus which evaluates the validity of a dictionary for converting a notation word written in a text, the apparatus comprising:
a dictionary recording portion which records, for each of word categories, at least one notation word in association with a canonical word representing the at least one notation word;
a relation recording portion which records, on the condition that a canonical word of one category corresponds to a notation word of another category, the dependence relation that the one category depends on the another category; and
an evaluation portion which evaluates, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word.

2. The apparatus according to claim 1, wherein
said relation recording portion records dependence degree indicating the degree of dependence relation of each category depending on each of other categories; and
said evaluation portion retrieves, on the condition that the canonical word of a first category corresponds to a notation word of a second category in the dictionary recording portion, the dependence degree corresponding to the relation between the first category and the second category from the relation recording portion and evaluates the retrieved dependence degree as the validity of the notation word.

3. The apparatus according to claim 1, further comprising:
an input portion which inputs specification of a new category from a user in association with the dependence relation that the new category depends on another category or the dependence relation that the another category depends on the new category; and
a warning portion which warns the user to the effect that dependence relation is inappropriate based on the inputted dependence relation and the dependence relations recorded in the relation recording portion, on the condition that the circulation relation is detected that one category depends on the new category, the new category depends on another category and the another category depends on the one category.

4. An apparatus which evaluates the validity of a dictionary for converting a notation word written in a text, the apparatus comprising:
a dictionary recording portion which records, for each of word categories, at least one notation word in association with a canonical word representing the at least one notation word;
a frequency recording portion which records a reference frequency, which is the appearance frequency at which a predetermined reference word appears in a predetermined reference text of a predetermined reference category;
a frequency calculation portion which calculates the appearance frequency at which a notation word recorded for the reference category in the dictionary recording portion appears in the reference text; and
an evaluation portion which evaluates, on the condition that the deviance of the appearance frequency calculated by the frequency calculation portion relative to the reference frequency is smaller, the validity of the notation word higher in comparison with the case where the deviance is larger.

5. The apparatus according to claim 4, wherein
said evaluation portion evaluates, on the condition that the appearance frequency of a notation word calculated by the frequency calculation portion is higher than the reference frequency, the notation word to be invalid.

6. The apparatus according to claim 4, wherein
said frequency recording portion records the appearance frequency at which a first reference word appears in the reference text and the appearance frequency at which a second reference word appears in the reference text; and
said evaluation portion evaluates, on the condition that the appearance frequency calculated by the frequency calculation portion is higher than the appearance frequency of one of the first and second reference words and lower than the appearance frequency of the other, the validity of the notation word higher than when the appearance frequency is higher than the appearance frequencies of both of the first and second reference words.

7. The apparatus according to claim 4, wherein
said frequency recording portion records, regarding the canonical word recorded in the dictionary recording portion as a reference word, the appearance frequency of the canonical word as the reference frequency;
said frequency calculation portion calculates the appearance frequency of a notation word corresponding to the canonical word; and
said evaluation portion evaluates the validity of the notation word based on the deviance of the appearance frequency of the notation word relative to the reference frequency of the canonical word.

8. An apparatus which evaluates the validity of a dictionary for converting a notation word written in a text, the apparatus comprising:
a dictionary recording portion which records at least one notation word in association with a canonical word representing the at least one notation word;
a text recording portion which records each of multiple texts in association with the attribute of the text;
a distribution recording portion which records, for a set of texts including a predetermined reference word, the distribution of the number of texts for each attribute;
a distribution generation portion which generates, for texts including the notation word recorded in the dictionary recording portion among the multiple texts recorded in the text recording portion, the distribution of the number of texts for each attribute; and
an evaluation portion which evaluates, on the condition that the deviance between the distribution of the number of texts recorded in the distribution recording portion and the distribution of the number of texts generated by the distribution generation portion is smaller, the validity of the notation word higher in comparison with the case where the deviance is larger.

9. The apparatus according to claim 8, wherein
the distribution recording portion records, regarding the canonical word recorded in the dictionary recording portion as a reference word, the distribution of the number of texts for each attribute for a set of texts including the canonical word; and
the evaluation portion evaluates the validity of a notation word based on the deviance between the distribution of the number of texts generated by the distribution generation portion for the notation word and the distribution with a canonical word corresponding to the notation word used as a reference word.

10. The apparatus according to claim 8, wherein
the dictionary recording portion records, for each of word categories, at least one notation word in association with a canonical word representing the at least one notation word; and
further comprises a relation recording portion which records, on the condition that a canonical word of one category corresponds to a notation word of another category, the dependence relation that the one category depends on the another category; and
the evaluation portion evaluates, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word; and
further evaluates, on the condition that the deviance between the distribution of the number of texts recorded in the distribution recording portion and the distribution of the number of texts generated by the distribution generation portion is larger than a predetermined criterion, the notation word to be invalid even if the dependence relation that the first category depends on the second category is recorded in the relation recording portion.

11. The apparatus according to claim 8, wherein
the dictionary recording portion records, for each of word categories, at least one notation word in association with a canonical word representing the at least one notation word; and
further comprises:
a frequency recording portion which records a reference frequency, which is the appearance frequency at which a predetermined reference word appears in a predetermined reference text of a predetermined reference category; and
a frequency calculation portion which calculates the appearance frequency at which a notation word recorded for the reference category in the dictionary recording portion appears in the reference text; and
the evaluation portion evaluates, on the condition that the deviance of the appearance frequency calculated by the frequency calculation portion relative to the reference frequency is larger than a predetermined criterion, the notation word to be invalid, and
further evaluates, on the condition that the deviance between the distribution of the number of texts recorded in the distribution recording portion and the distribution of the number of texts generated by the distribution generation portion is larger than a predetermined criterion, the notation word to be invalid even if the deviance is equal to or below the predetermined criterion.

12. The apparatus according to claim 11, further comprising a relation recording portion which records, on the condition that a canonical word of one category corresponds to a notation word of another category, the dependence relation that the one category depends on the another category; wherein
the evaluation portion evaluates, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word;
further evaluates, on the condition that the deviance of the appearance frequency calculated by the frequency calculation portion relative to the reference frequency is larger than a predetermined criterion, the notation word to be invalid even if the dependence relation that the first category depends on the second category is recorded in the relation recording portion; and
further evaluates, on the condition that the deviance between the distribution of the number of texts recorded in the distribution recording portion and the distribution of the number of texts generated by the distribution generation portion is larger than a predetermined criterion, the notation word to be invalid even if the deviance is equal to or below the predetermined criterion.

13. The apparatus according to claim 11, wherein
the frequency recording portion records the appearance frequency at which a first reference word appears in the reference text and the appearance frequency at which a second reference word appears in the reference text; and
the evaluation portion evaluates, on the condition that the appearance frequency calculated by the frequency calculation portion is higher than the appearance frequencies of both of the first and second reference words, the notation word to be invalid;
evaluates, on the condition that the appearance frequency calculated by the frequency calculation portion is lower than the appearance frequencies of both of the first and second reference words, the notation word to be valid; and
evaluates, on the condition that the appearance frequency calculated by the frequency calculation portion is higher than the appearance frequency of one of the first and second reference words and lower than the appearance frequency of the other, the deviance between the distribution of the number of texts recorded in the distribution recording portion and the distribution of the number of texts generated by the distribution generation portion.

14. A method for evaluating the validity of a dictionary for converting a notation word written in a text by an information processing apparatus, the information processing apparatus being provided with:
a dictionary recording portion which records, for each of word categories, at least one notation word in association with a canonical word representing the at least one notation word; and
a relation recording portion which records, on the condition that a canonical word of one category corresponds to a notation word of another category, the dependence relation that the one category depends on the another category; and
the method comprising evaluating, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word.

15. A program for causing an information processing apparatus to function as an apparatus which evaluates the validity of a dictionary for converting a notation word written in a text, the program causing the information processing apparatus to function as:
a dictionary recording portion which records, for each of word categories, at least one notation word in association with a canonical word representing the at least one notation word;
a relation recording portion which records, on the condition that a canonical word of one category corresponds to a notation word of another category, the dependence relation that the one category depends on the another category; and
an evaluation portion which evaluates, on the condition that the canonical word of a first category corresponds to a notation word of a second category in the dictionary recording portion and that the dependence relation that the first category depends on the second category is not recorded in the relation recording portion, the notation word to be invalid as a word represented by the canonical word.

16. A method for evaluating the validity of a dictionary for converting a notation word written in a text by an information processing apparatus, the information processing apparatus being provided with:
a dictionary recording portion which records, for each of word categories, at least one notation word in association with a canonical word representing the at least one notation word; and
a frequency recording portion which records a reference frequency, which is the appearance frequency at which a predetermined reference word appears in a predetermined reference text of a predetermined reference category; and
the method comprising:
calculating the appearance frequency at which a notation word recorded for the reference category in the dictionary recording portion appears in the reference text; and
evaluating, on the condition that the deviance of the calculated appearance frequency relative to the reference frequency is smaller, the validity of the notation word higher in comparison with the case where the deviance is larger.

17. A program for causing an information processing apparatus to function as an apparatus which evaluates the validity of a dictionary for converting a notation word written in a text, the program causing the information processing apparatus to function as:
a dictionary recording portion which records, for each of word categories, at least one notation word in association with a canonical word representing the at least one notation word;
a frequency recording portion which records a reference frequency, which is the appearance frequency at which a predetermined reference word appears in a predetermined reference text of a predetermined reference category;
a frequency calculation portion which calculates the appearance frequency at which a notation word recorded for the reference category in the dictionary recording portion appears in the reference text; and
an evaluation portion which evaluates, on the condition that the deviance of the appearance frequency calculated by the frequency calculation portion relative to the reference frequency is smaller, the validity of the notation word higher in comparison with the case where the deviance is larger.

18. A method for evaluating the validity of a dictionary for converting a notation word written in a text by an information processing apparatus, the information processing apparatus being provided with:
a dictionary recording portion which records at least one notation word in association with a canonical word representing the at least one notation word;
a text recording portion which records each of multiple texts in association with the attribute of the text; and
a distribution recording portion which records, for a set of texts including a predetermined reference word, the distribution of the number of texts for each attribute; and
the method comprising:
generating, for texts including the notation word recorded in the dictionary recording portion among the multiple texts recorded in the text recording portion, the distribution of the number of texts for each attribute; and
evaluating, on the condition that the deviance between the distribution of the number of texts recorded in the distribution recording portion and the distribution of the number of texts generated by the distribution generation step is smaller, the validity of the notation word higher in comparison with the case where the deviance is larger.

19. A program for causing an information processing apparatus to function as an apparatus which evaluates the validity of a dictionary for converting a notation word written in a text, the program causing the information processing apparatus to function as:
a dictionary recording portion which records at least one notation word in association with a canonical word representing the at least one notation word;
a text recording portion which records each of multiple texts in association with the attribute of the text;
a distribution recording portion which records, for a set of texts including a predetermined reference word, the distribution of the number of texts for each attribute;
a distribution generation portion which generates, for texts including the notation word recorded in the dictionary recording portion among the multiple texts recorded in the text recording portion, the distribution of the number of texts for each attribute; and
an evaluation portion which evaluates, on the condition that the deviance between the distribution of the number of texts recorded in the distribution recording portion and the distribution of the number of texts generated by the distribution generation portion is smaller, the validity of the notation word higher in comparison with the case where the deviance is larger.
